(19) United States
(12) Patent Application Publication
(10) Pub. No.: US 2021/0080119 A1
(43) Pub. Date: Mar. 18, 2021

(54) DIRECT FIRED APPLIANCE

(71) Applicant: BECKETT GAS, INC., North Ridgeville, OH (US)

(72) Inventor: MICHAEL J. O'DONNELL, Avon, OH (US)

(21) Appl. No.: 16/603,263

(22) PCT Filed: Apr. 10, 2018
(86) PCT No.: PCT/US2018/026869

§ 371 Date: Oct. 7, 2019

Related U.S. Application Data
(60) Provisional application No. 62/483,529, filed on Apr. 10, 2017.

(51) Int. Cl. F24C 15/32; A21B 1/28

(52) U.S. Cl. CPC F24C 15/325; F24C 3/128; A21B 1/28

(57) ABSTRACT

A fluid directing structure for a direct fired appliance having a heating space, a burner for providing heat to the heating space, and an exhaust includes a duct. The duct includes a first passage extending from a first end adjacent the burner to a second end fluidly connected to the exhaust. A second passage extends from a first end fluidly connected to the first passage to a second end fluidly connected to the heating space. A damper is connected to the duct and has a first condition directing fluid flow from the first end of the first passage to the second end of the first passage while preventing fluid flow to the second passage. The damper has a second condition directing fluid flow from the first end of the first passage to the second passage while preventing fluid flow to the second end of the first passage.

### RELATED APPLICATIONS

This application claims the benefit of U.S. Provisional Appln. Ser. No. 62/483,529, filed Apr. 10, 2017, the entirety of which is incorporated herein by reference.

### TECHNICAL FIELD

The present invention relates generally to appliances and, more specifically relates to a direct fired appliance having a controllable fluid directing system.

### BACKGROUND

In direct fired appliances, e.g., ovens, an undesirable condition can occur if, during the burner off cycle, raw gas leaks into the oven chamber. Some gas appliance safety standards require four air changes of the combustion chamber (the oven cavity in the case of an oven) before attempting burner ignition. In an oven application, changing the air in the oven cavity four times every time the burner needs to light could cause unacceptable temperature swings and efficiency loss.

### SUMMARY

In accordance with the present invention, a fluid directing system for a direct fired appliance having a heating space, a burner for providing heat to the heating space, and an exhaust includes a duct. The duct includes a first passage extending from a first end adjacent the burner to a second end fluidly connected to the exhaust. A second passage extends from a first end fluidly connected to the first passage to a second end fluidly connected to the heating space. A damper is connected to the duct and has a first condition directing fluid flow from the first end of the first passage to the second end of the first passage while preventing fluid flow to the second passage. The damper has a second condition directing fluid flow from the first end of the first passage to the second passage while preventing fluid flow to the second end of the first passage.

In another example, a direct fired appliance includes a housing defining a heating space and a burner providing heat to the heating space. An exhaust is in fluid communication with the burner. A fluid directing structure includes a duct having a first passage extending from a first end adjacent the burner to a second end fluidly connected to the exhaust. A second passage extends from a first end fluidly connected to the first passage to a second end fluidly connected to the heating space. A damper is connected to the duct and has a first condition directing fluid flow from the first end of the first passage to the second end of the first passage while preventing fluid flow to the second passage. The damper has a second condition directing fluid flow from the first end of the first passage to the second passage while preventing fluid flow to the second end of the first passage.

Other objects and advantages and a fuller understanding of the invention will be had from the following detailed description and the accompanying drawings.

### BRIEF DESCRIPTION OF THE DRAWINGS

FIG. 1 illustrates one example commercial, direct fired appliance in accordance with the present invention.

FIG. 2 is a section view of the appliance of FIG. 1 taken along line 2-2.

FIG. 3A is an enlarged view of a portion of FIG. 2 with a damper of the appliance in a first condition.

FIG. 3B is an enlarged view of a portion of FIG. 2 with the damper of the appliance in a second condition.

FIG. 4 illustrates another example appliance including a steam generating system.

FIG. 5 is a section view of a portion of the steam generating system of FIG. 4.

### DETAILED DESCRIPTION

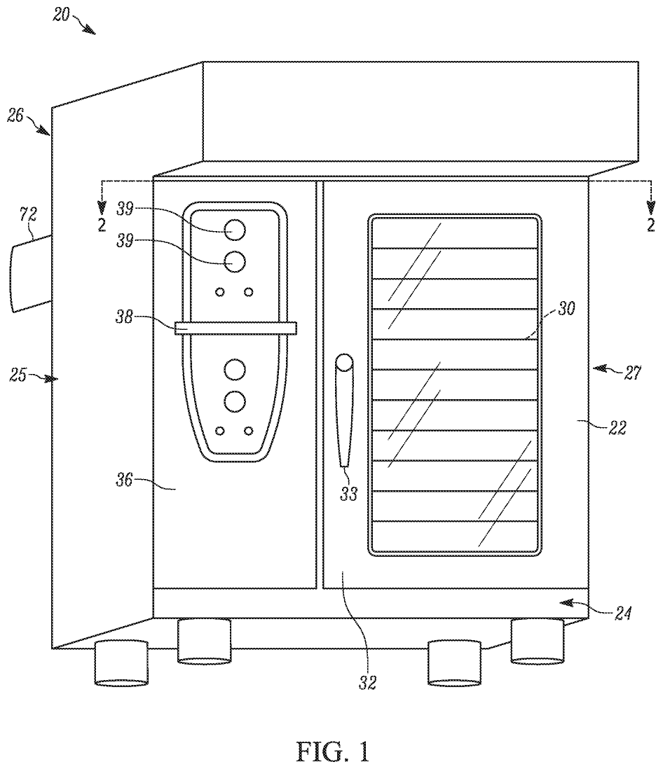

The present invention relates generally to appliances and, more specifically relates to a direct fired appliance having a controllable fluid directing system. FIGS. 1-3A illustrates an example direct fired appliance 20 in accordance with an aspect of the invention. Although the appliance shown is a commercial oven it will be appreciated that other direct fired appliances are contemplated by the present invention.

In FIG. 1, the oven 20 includes a housing 22 having a front side 24 and a rear side 26. Lateral sides 25, 27 extend between the front and rear sides 24, 26. The housing 22 defines a heating space 30 (an oven cavity in this example) therein in which food is heated/cooked/prepared. Although a single oven cavity 30 is shown multiple oven cavities can be provided in the housing 22 and divided by partitions (not shown).

A first door 32 having a handle 33 is pivotably connected to the front side 24 of the housing 22 for selectively providing access to the oven cavity 30. A second door 36 having a handle 38 is pivotably connected to the front side 24 of the housing 22 for selectively providing access to the oven controls 39. An exhaust or vent 72 extends from the housing 22.

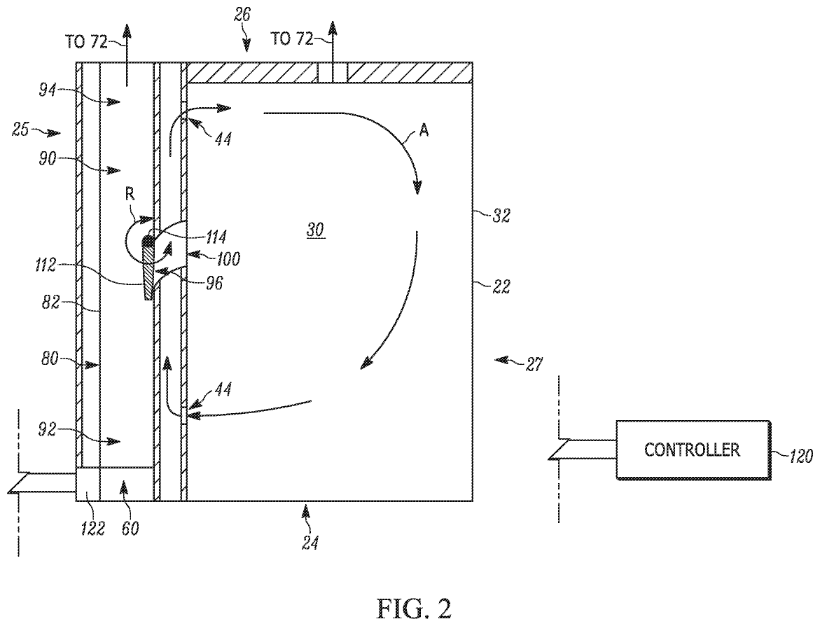

Referring to FIG. 2, a burner 60 is associated with the oven cavity 30 for supplying a flame providing hot flue gasses to the oven cavity. The burner 60 can constitute a gas burner, such as the gas burner shown and described in U.S Pat. No. 9,528,698, the entirety of which is incorporated by reference herein. A fluid directing or control system 80 is provided in the oven 20 for selectively controlling fluid communication between the burner 60, the oven cavity 30, and the exhaust 72.

The fluid directing system 80 includes a tube or duct 82 within the housing 22. As shown, the duct 82 extends horizontally along the rear side 26 of the housing 22 between the lateral sides 25, 27. The duct 82 can be formed as part of the housing 22 or as a separate component secured thereto. The duct 82 defines a first passage 90 that extends from a first end 92 adjacent the side 25 of the oven 20 to a second end 94 adjacent the side 27. The first end 92 is in fluid communication with the output of the burner 60.

A second passage 100 extends from an opening 96 in fluid communication with the first passage 90 and located between the first and second ends 92, 94. The second passage 100 extends from a first end at the opening 96 to a second end in fluid communication with/exposed to the oven cavity 30.

Openings 44 are provided in the duct 82 to fluidly connect the first passage 90 and oven cavity 30 to allow air and flue gases to recirculate between/through the oven cavity 30 and first passage in the manner indicated by the arrows A to help prevent the first passage from overheating. The openings 44 are provided on opposite sides of the second passage 100.

A damper 112 is provided at the opening 96 between the first passage 90 and second passage 100. The damper 112 can constitute a valve or flap connected to the duct 82 and capable of dictating fluid flow between and through the passages 90, 100 and the oven cavity 30. The damper 112 is secured to the housing 22 at a hinged connection 114 that allows the damper to pivot or rotate about the connection as indicated generally by the arrow “R”.

The damper 112 is electrically connected to and controlled by a controller 120 on the oven 20. The controller 120 is also electrically connected to a flame-proving device 122 associated with each burner 60 for notifying the controller when a flame is present [or not] on each burner.

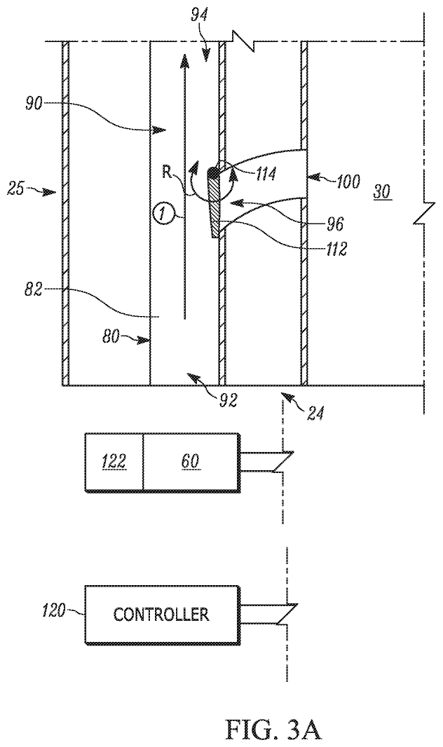

In one example, the damper 112 has a first condition (FIG. 3A) closing the opening 96 and obstructing the second passage 100. As a result, any fluid entering the first end 92 of the first passage 90 will flow to the second end 94 of the first passage and be prevented from entering the second passage 100. The damper 112 is placed in the first condition during the initial oven 20 start-up, i.e., while the burner 60 is turned off, during pre-ignition purging of the passage 90, and during ignition. As a result, any raw gas exiting the “off” burner 60 and passing into the first end 92 of the first passage 90 will flow as shown along the path (1) out the second end 94 of the first passage to the exhaust 72 (see FIG. 2) leading out of the oven 20.

In the first condition of the damper 112, the oven cavity 30 is fluidly isolated from the first passage 90 and, thus, no raw gas will flow through the second passage 100 into the oven cavity 30. Isolating the first passage 90 from the oven cavity 30 also means that, upon initiation of the burner cycle, only the first passage [and not the entire oven cavity] needs to be purged before burner ignition. The relatively smaller purging volume advantageously reduces the purging time and increases purging efficacy.

Once the burner 60 is on/lit, which can be confirmed by the flame-proving device 122, the damper 112 is actuated to a second condition (FIG. 3B). More specifically, the controller 120 pivots the damper 112 in the counterclockwise manner R about the connection 114 out of the opening 96 and into the first passage 90. Consequently, the opening 96 becomes unobstructed and the first passage 90 becomes obstructed downstream of the damper 112, i.e., at the second end 94.

Any fluid—such as the hot combustion products produced by the flame F of the burner 60—entering the first end 92 of the first passage 90 will therefore flow through the opening 96 to the second passage 100. The damper 112 prevents any fluid from flowing to the second end 94 of the first passage 90. Due to this configuration, the damper 112 can control the flow of any fluid entering the first end 92 of the first passage 90 and thereby dictate whether that fluid will flow to the second end 94 of the first passage or flow to the second passage 100.

Although the flame-proving device 122 is used to control actuation of the damper 112, it will be appreciated that the damper could alternatively/additionally be actuated in response to another sensed condition within the appliance 20. In any case, hot combustion products from the burner 60 flow as shown along the path (2) from the first end 92 of the first passage 90, through the opening 96, through the second passage 100, and into the oven cavity 30 to heat the oven cavity and any contents therein. Flue gases flow from the oven cavity 30 and exit the oven 20 through the exhaust 72.

Although the fluid directing system 80 is discussed with regard to one oven cavity 30 it will be appreciated that the same/similar duct 82 and damper 112 configuration can be used for each cavity as part of the same or separate fluid directing system. One burner 60 can supply heat to every oven cavity 30 or each cavity can be associated with its own burner Consequently, the fluid directing system 80 can us a multi-duct configuration with a single damper 112 or multiple dampers actuatable independently or simultaneously depending on the heating demand within the cavities 30.

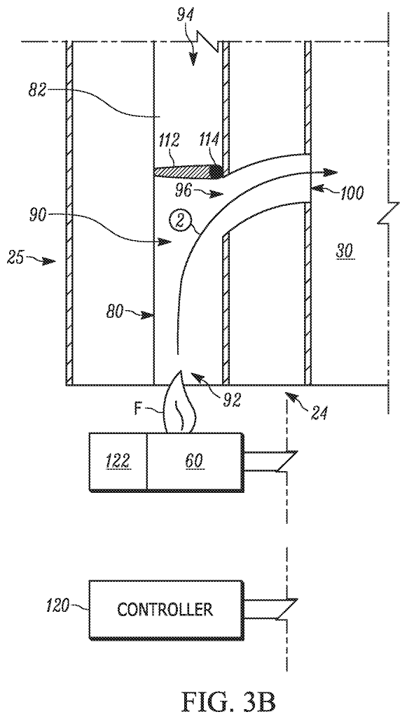

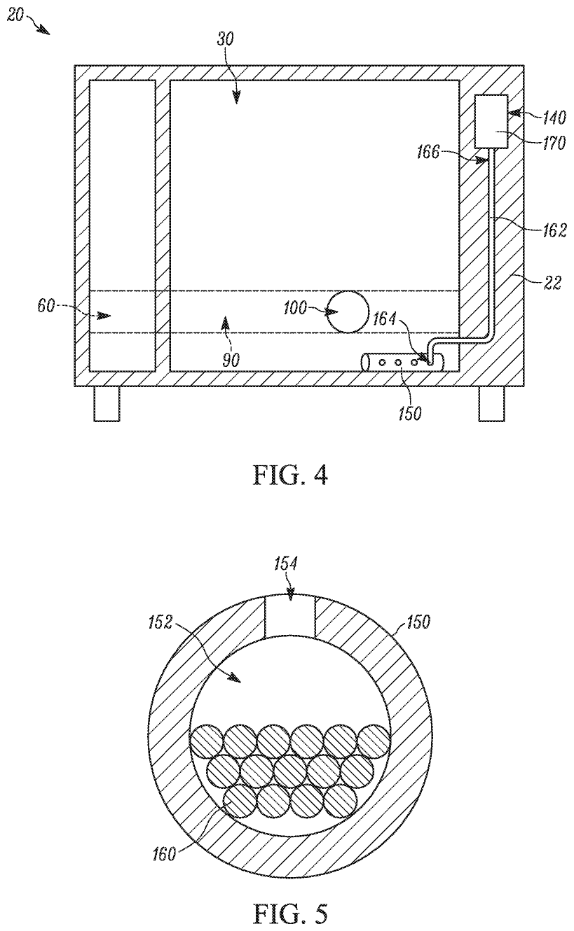

FIGS. 4-5 illustrate another example oven 20 that also includes a steam generating system 140. An example stand-alone steam-generating oven is shown and described in U.S. Pat. No. 8,288,690, the entirety of which is incorporated by reference herein and attached in the Appendix. An example oven that includes both burners and a steam-generating device, e.g., a water reservoir that delivers water to heated steel balls, is shown and described in U.S. Pat. No. 6,860,261, the entirety of which is incorporated by reference herein.

As shown, the steam generating system 140 includes a tubular body 150, such as a stainless steel pipe capped at both ends. A central passage 152 extends between the two ends. Radial openings 154 are provided along the length of the body 150 and extend to the central passage 152. The openings 154 are oriented to face generally towards the center of the oven cavity 30—as opposed to towards the housing 22. A thermal mass 160, e.g., stainless steel balls, is provided in the central passage 152. A water line 162 extends through or is connected to the housing 22 and includes an outlet end 164 connected to one of the openings 154. An inlet end 166 of the line 162 is connected to a reservoir 170 for supplying water to thereto. The reservoir 170 is therefore fluidly connected to the central passage 152 in the body 150.

Certain foods respond beneficially to steam during the cooking process. An example steam cycle would be as follows: the oven cavity 30 is brought up to a desired temperature and then the burner 60 shut off. This heats the thermal mass 160 to at least a predetermined temperature, e.g., hot enough to vaporize water. The controller 120 then places the damper 112 in the closed, first condition (FIG. 3A).

Water from the reservoir 170 is pumped or fed to the line 162 and flows to the outlet end 164 thereof. The water passes through the outlet end 164 and is vaporized to steam upon contact with the thermal mass 160. The steam passes through the openings 154 into the oven cavity 130. The inlet and/or outlet end 164, 166 of the line 162 can be pinched as desired to feed the water into the central passage 152 at a desired rate. The thermal mass 160 captures sufficient heat prior to introduction of the water to flash the water from the body 150 via the openings 154 when needed.

Actuating the damper 112 of the present invention to the first condition prior to using the steam generating system 140 prevents steam from flowing through the second passage 100 and into contact with the gas burner(s) 60 or control compartment. In other words, the damper 112 can be actuated to close the/any fluid path between the oven cavity 30 and gas burner 60 to prevent affecting or damaging the burner or controls.

Once the steam cycle is complete water ceases flowing to the line 162. The first passage 90 is purged and the burner 60 is re-lit. When the flame-proving device 122 indicates a flame F, the controller 120 places the damper 112 in the open, second condition (FIG. 3B) for heating the oven cavity 30 via the hot combustion products.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A fluid directing system for a direct fired appliance having a heating space, a burner for providing heat to the heating space, and an exhaust, comprising:
a duct including:
a first passage extending from a first end adjacent the burner to a second end fluidly connected to the exhaust, and
a second passage extending from a first end fluidly connected to the first passage to a second end fluidly connected to the heating space; and
a damper connected to the duct and having a first condition directing fluid flow from the first end of the first passage to the second end of the first passage while preventing fluid flow to the second passage, the damper having a second condition directing fluid flow from the first end of the first passage to the second passage while preventing fluid flow to the second end of the first passage.

2. The fluid directing structure recited in claim 1, wherein the damper is moved between the first condition and the second condition in response to a signal from a flame-proving device associated with the burner.

3. The fluid directing structure recited in claim 2 further comprising a controller electrically connected to the flame-proving device and to the damper for moving the damper between the first condition and the second condition.

4. The fluid directing structure recited in claim 1, wherein the damper is a flap pivotably connected to the duct.

5. The fluid directing structure recited in claim 1, wherein the damper is provided in an opening fluidly connecting the first passage with the second passage.

6. The fluid directing structure recited in claim 5, wherein the damper blocks the opening when in the first condition and is pivoted out of the opening when in the second condition.

7. The fluid directing structure recited in claim 1, wherein the damper is actuatable to prevent steam from flowing into the burner from a steam-generating system of the appliance.

8. The fluid directing structure recited in claim 1, wherein the damper is placed in the first condition when the burner is off, during purge, and during burner ignition.

9. The fluid directing structure recited in claim 1, wherein the damper is placed in the second condition once the burner is lit.

10. The fluid directing structure recited in claim 1, wherein the duct is secured to a housing of the appliance defining the heating space.

11. A direct fired appliance comprising:
a housing defining a heating space;
a burner for providing heat to the heating space,
an exhaust in fluid communication with the burner;
a fluid directing structure comprising:
a duct including:
a first passage extending from a first end adjacent the burner to a second end fluidly connected to the exhaust, and
a second passage extending from a first end fluidly connected to the first passage to a second end fluidly connected to the heating space; and
a damper connected to the duct and having a first condition directing fluid flow from the first end of the first passage to the second end of the first passage while preventing fluid flow to the second passage, the damper having a second condition directing fluid flow from the first end of the first passage to the second passage while preventing fluid flow to the second end of the first passage.

12. The direct fired appliance recited in claim 11 further comprising a steam-generating system for providing steam to the heating space, wherein the damper is actuatable to the first condition to prevent steam from flowing into the burner.

13. The direct fired appliance recited in claim 11, wherein the damper is moved between the first condition and the second condition in response to a signal from a flame-proving device associated with the burner.

14. The direct fired appliance recited in claim 13 further comprising a controller electrically connected to the flame-proving device and to the damper for moving the damper between the first condition and the second condition.

15. The direct fired appliance recited in claim 11, wherein the damper is a flap pivotably connected to the duct.

16. The direct fired appliance recited in claim 11, wherein the damper is placed in the first condition when the burner is off, during purge, and during burner ignition.

17. The direct fired appliance recited in claim 11, wherein the damper is placed in the second condition once the burner is lit.

18. The direct fired appliance recited in claim 1, wherein the damper is provided in an opening fluidly connecting the first passage with the second passage.

19. The direct fired appliance recited in claim 18, wherein the damper blocks the opening when in the first condition and is pivoted out of the opening when in the second condition.

20. The direct fired appliance recited in claim 1, wherein the duct is provided in the housing.
